(19) United States
(12) Patent Application Publication
(10) Pub. No.: US 2024/0221095 A1
(43) Pub. Date: Jul. 4, 2024

(54) INTENT-BASED ITEM RECOMMENDATIONS

(71) Applicant: Coupa Software Incorporated, San Mateo, CA (US)

(72) Inventors: Devon Tivona, Denver, CO (US); Kimberly Wagner, Denver, CO (US); Katie Kenney, Durham, NC (US); Nicola Milne, Denver, CO (US)

(21) Appl. No.: 18/390,712

(22) Filed: Dec. 20, 2023

Related U.S. Application Data
(60) Provisional application No. 63/436,232, filed on Dec. 30, 2022.

(51) Int. Cl. G06Q 50/14; G06Q 10/02

(52) U.S. Cl. CPC G06Q 50/14; G06Q 10/02

(57) ABSTRACT

Embodiments disclose a computer-implemented method that is implemented using a travel and expense application. The method includes receiving trip input data comprising the origin of travel, the destination of the travel, and the period of an event from a web-based application implemented in a computing device of a candidate. The trip input data associated with an event record having an event identifier of the event. The method populates a plurality of trip fields of a travel database having a plurality of trip database records with the event identifier associated with the trip input data to automatically create and store a trip record for a new trip of the candidate. The travel database is communicatively coupled to the travel and expense application. The method then automatically creates, for the new trip, a database search query for a plurality of data servers based on a plurality of search criteria associated with the candidate. The plurality of search criteria comprises a plurality of candidate preference data, candidate historical booking patterns, booking intents associated with the event, and the trip input data. The method automatically executes the database search query for the new trip to provide a plurality of recommendations including commute options and accommodation options based on the plurality of search criteria. The method receives a selection of one of a commute option and an accommodation option among the plurality of recommendations for the new trip, and in response to receiving the selection, automatically creating booking information corresponding to booking a commute option among the commute options and an accommodation option among the accommodation options. The method then updates an itinerary of the new trip of the candidate with the booking information and presenting the booking information and the plurality of recommendations at a graphical user interface (GUI) of the computing device of the candidate.

### BENEFIT CLAIM

This application claims the benefit under 35 U.S.C. § 119(e) of provisional patent application 63/436,232, filed Dec. 30, 2022, the entire contents of which are hereby incorporated by reference as if fully set forth herein. Applicant hereby rescinds any disclaimer of claim scope in the application(s) of which the benefit is claimed and advises the USPTO that the present claims may be broader than any application(s) of which the benefit is claimed.

### COPYRIGHT NOTICE

A portion of the disclosure of this patent document contains material that is subject to copyright protection. The copyright owner has no objection to the facsimile reproduction by anyone of the patent document or the patent disclosure, as it appears in the Patent and Trademark Office patent file or records, but otherwise reserves all copyright or rights. @ 2021-2022 Coupa Software Incorporated.

### TECHNICAL FIELD

One technical field of the present disclosure is relational database systems, including automated transformations of database records.

### BACKGROUND

The approaches described in this section are approaches that could be pursued but not necessarily approaches that have been previously conceived or pursued. Therefore, unless otherwise indicated, it should not be assumed that any of the approaches described in this section qualify as prior art merely by their inclusion in this section.

Digital relational databases are now widely used to store, manage, and control the flow of information in business enterprises, with integration into a variety of practical applications. One example application is employee travel booking and expense management. In many business enterprises, employees or contractors incur external travel expenses in the course and scope of employment and are entitled to reimbursement from the enterprise for those expenses. To manage the collection, review, and approval of travel expense information, enterprises use travel booking and expense management software linked to relational databases.

Travel costs are a significant portion of employee expenses for some enterprises and their employees. Business travel can involve costs of thousands of dollars per trip and hundreds of thousands of dollars per employee per year. Therefore, to manage the creation or collection, review, and approval of travel expense information, enterprises use travel expense management software linked to relational databases. In some cases, but not all, general expense management is linked to travel management.

Some enterprises enter into long-term cost-control contracts with travel service providers. For example, enterprises may have volume discount contracts with airlines, rental car companies, hotel operators or chains, and restaurant operators or chains. Because of the volume and complexity of these contracts, relational databases also can be used to create, manage, and distribute information about records of contracts.

In this context, the efficiency of database search systems becomes important. Employees who conduct repeated trips for the same purpose or to the same destination should not have to repeat search queries to obtain similar information compared to past trips or sift through dozens of listings to find flights, hotels, and other bookings that are acceptable. Or, if an individual conducts a search but is interrupted without completing bookings, the individual should not be required to repeat the same specific search query to obtain desired information. Repeated searches, or repeated filtering of the same search results, require individuals to incur time and costs that could be avoided with more intelligent search tools. Therefore, the travel booking and expense fields have an acute need for improved computer-based search systems.

### SUMMARY

The appended claims may serve as a summary of the invention.

### BRIEF DESCRIPTION OF THE DRAWINGS

In the drawings:

FIG. 1 illustrates a distributed computer system showing the context of use and principal functional elements with which one embodiment could be implemented.

FIG. 2 is a flow diagram of an algorithm that can be programmed to implement one embodiment.

FIG. 3, FIG. 4, FIG. 5, FIG. 6A, and FIG. 6B illustrate example graphical user interfaces that can be generated and presented for embodiments.

FIG. 7 illustrates a computer system with which one embodiment could be implemented.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

The text of this disclosure, in combination with the drawing figures, is intended to state in prose the algorithms that are necessary to program the computer to implement the claimed inventions at the same level of detail that is used by people of skill in the arts to which this disclosure pertains to communicate with one another concerning functions to be programmed, inputs, transformations, outputs and other aspects of programming. That is, the level of detail set forth in this disclosure is the same level of detail that persons of skill in the art normally use to communicate with one another to express algorithms to be programmed or the structure and function of programs to implement the inventions claimed herein.

### 1. General Overview

Embodiments provide computer-implemented methods and distributed computer systems that are configured and programmed to support intent-based travel database search queries and the automatic formation of database records relating to travel plans based on traveler intent rather than specific search queries. Intent, in this context, can consist of user input specifying a destination and a date or period of an event for travel or travel plans. Thus, the traveler specifies, by computer input, where they need to be and when. In response, embodiments are programmed to automatically form search queries that are likely to generate helpful recommendations, execute the search queries, and present the results. For example, a traveler could trip input data specifying that they need to be in San Francisco for a meeting that starts at 9 am and ends at 5 pm on a particular date. In response, embodiments are programmed to intelligently generate search queries for flights that are compatible with the specified schedule, accounting for factors such as commute time and historical traffic data between their destinations. In another embodiment, a user can input trip data specifying the purpose of a trip, for example, “Sales Trip,” and the embodiment is programmed to recommend purchase decisions for the traveler based on search queries that are automatically generated and executed. Search results can be transmitted using push notifications to a compatible application executing on a mobile computing device or in a notification of a browser-based application. As another example, if a traveler specifies that they are attending an internal company event, an embodiment can be programmed to recommend that the traveler carpool with other coworkers who might be arriving at similar times.

### 2. Structural & Functional Overview

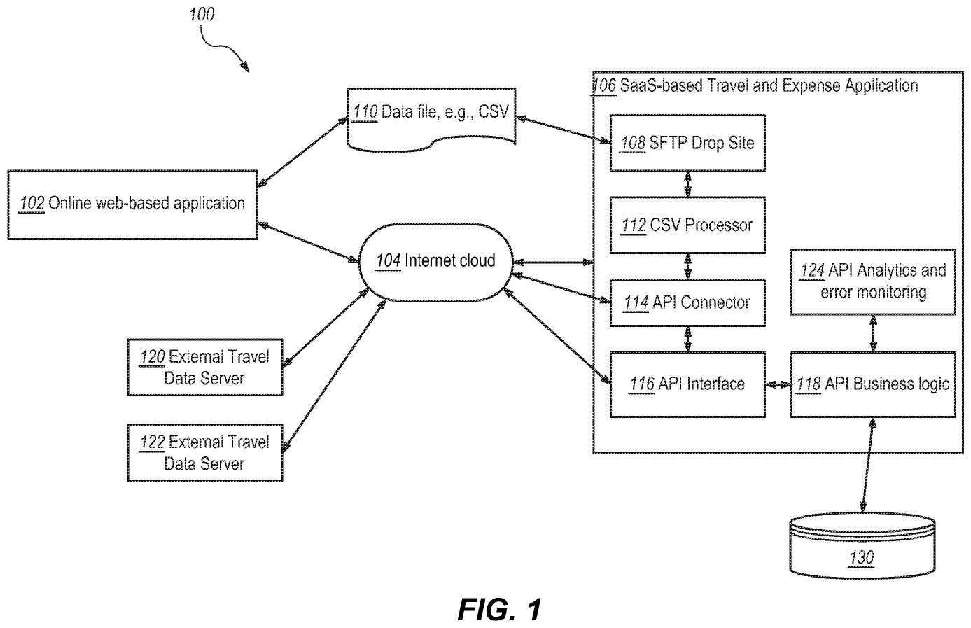

FIG. 1 illustrates a distributed computer system showing the context of use and principal functional elements with which one embodiment could be implemented.

In an embodiment, a computer system 100 comprises components that are implemented at least partially by hardware at one or more computing devices, such as one or more hardware processors executing stored program instructions stored in one or more memories for performing the functions that are described herein. In other words, all functions described herein are intended to indicate operations that are performed using programming in a special-purpose computer or general-purpose computer in various embodiments. FIG. 1 illustrates only one of many possible arrangements of components configured to execute the programming described herein. Other arrangements may include fewer or different components, and the division of work between the components may vary depending on the arrangement.

FIG. 1, and the other drawing figures and all of the description and claims in this disclosure, are intended to present, disclose, and claim a technical system and technical methods in which specially programmed computers, using a special-purpose distributed computer system design, execute functions that have not been available before to provide a practical application of computing technology to the problem of machine learning model development, validation, and deployment. In this manner, the disclosure presents a technical solution to a technical problem, and any interpretation of the disclosure or claims to cover any judicial exception to patent eligibility, such as an abstract idea, mental process, method of organizing human activity, or mathematical algorithm, has no support in this disclosure and is erroneous.

System 100, having a plurality of components, may include an online web-based application 102, such as a conference planning or event planning system, that is communicatively coupled to a telecommunications network such as Internet cloud 104. A software as a service (SaaS) based travel and expense application 106, independent of the online web-based application 102 and usually with a different owner, operator, or manager, also is coupled to Internet cloud 104. A plurality of likewise independent external travel data servers 120 and 122 are coupled to Internet cloud 104. In an embodiment, SaaS-based travel and expense application 106 comprises a secure file transfer platform (SFTP) drop site 108, comma-separated value (CSV) processor 112, application programming interface (API) connector 114, API interface 116, API business logic 118, API analytics and error monitoring 124. In an embodiment, the SFTP drop site 108 receives a data file 110, such as a CSV from the online web-based application 102. An AWS SFTP server that uses an AWS S3 bucket as its file system can be used. CSV processor 112 parses out each line into a data element. The API connector 114 takes each data element and makes the appropriate API calls to servers 120, 122. The API interface 116 accepts and validates requests. The API business logic 118 makes the necessary updates in database 130, holding travel and expense records. The API analytics and error monitoring 124 may utilize Datadog as one example. Other optional system components may include API documentation, an API authentication system, an API load balancer, and a component for protecting against malicious activities (distributed denial of service (DDoS), Bots, etc.)

### 2. Intent-Based Record Creation—Implementation Examples

### 2.1 Start a Trip Automation

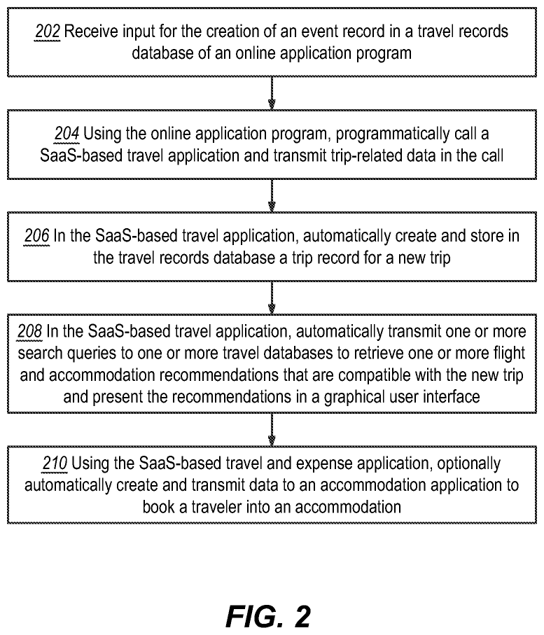

Embodiments are programmed to create automatically and digitally store database records representing a planned trip in response to detecting the creation of other records or other data entries relating to future events. FIG. 2 illustrates an example algorithm that could be programmed. FIG. 2 and each other flow diagram herein are intended as an illustration of the functional level at which skilled persons, in the art to which this disclosure pertains, communicate with one another to describe and implement algorithms using programming. The flow diagrams are not intended to illustrate every instruction, method object, or sub-step that would be needed to program every aspect of a working program but are provided at the same functional level of illustrations that are normally used at the high level of skill in this art to communicate the basis of developing working programs. Referring to FIG. 2, block 202, block 204, and block 206, in one embodiment, the “Start A Trip” action is programmatically initiated by passing in trip input data fields in the programmatic call of block 204. The trip input data fields may include the trip start date, trip stop date, origin airport code, destination airport code, and one or more custom field key/value pairs. In an embodiment, the trip input data corresponds to an event record creation in the database 130.

In an embodiment, when a user registers for an event in a SaaS-based event registration system, such as “CVENT” or “BIZLY,” the embodiment at block 206 is programmed to automatically create a trip record in the travel records database for a new trip and to automatically populate one or more trip fields of the event record in the travel records database 130, such as event identifier of the event record created for the trip input data. Furthermore, as shown in FIG. 2, block 208, the embodiment is programmed to automatically initiate and transmit one or more travel database search queries to one or more travel databases to retrieve commute and accommodation options, for example, flight and hotel options as recommendations that are compatible with the new trip. For example, the one or more travel database search queries are transmitted to external travel data servers 120 and 122 to retrieve flights and accommodation recommendations for the new trip. In an embodiment, at block 208, the flights and accommodations recommendations are presented in a graphical user interface of a computer/computing device associated with the online web-based application 102 of the traveler/user/candidate/travel manager. In an embodiment, the computer/computing device may be associated with the SaaS-based travel and expense application 106.

In an embodiment, at block 210, the SaaS-based travel and expense application 106 is programmed to automatically create and transmit data, including the recommendations of the flights and accommodations, to an accommodation application to book a traveler into an accommodation. In an embodiment, the accommodation application may be associated with the external travel data servers 120 and 122. In some embodiments, the traveler is booked to flights based on the recommendations. In an embodiment, when attendees or travelers register for Anthem events, they are automatically booked into a hotel room block for that event in the background based on the type of the event. Anthem specifies a particular event type or event type determined from the event and wants to be able to put that hotel on the itinerary of this new trip so that the traveler knows that they do not need to book a hotel. They are able to pass the information about the hotel to us via the same data feed that includes the traveler registration information.

In an embodiment, when a new hire signs up for an onboarding class, the system 100 is programmed to automatically create a trip for them (they would need to be provisioned as a “Limited Traveler” as well) and a “TravelPass” authorized for this trip.

In an embodiment, system 100 receives a consolidated data feed of event registration data. The event registration data includes the end user's email and origin, destination, dates, travel shopping parameters, event details, and room block details. Using this data feed, the system 100 can be programmed to automatically create a trip on the end user's dashboard that will display the event name and dates. Within this trip, the system 100 may suggest flights that are compatible with the event dates. In an embodiment, the system 100 also is programmed to send an email to the traveler providing details on the room that has been held for them as part of the room block. All details transferred via the data feed, including, but not limited to, event data, for example (1) meeting ID/event ID, (2) meeting/event name, (3) meeting/event start and end date, (4) meeting/event address, (5) event/meeting venue name, and (6) event/meeting venue city will be available to Anthem in all relevant data reporting. Meeting data will include a timestamp or a period for any active or passive segment changes in an event related to the meeting. The system 100 is programmed to identify by date and timestamp any segment change in a passenger name record (PNR). The system 100 is programmed to add a passive segment to the traveler's itinerary on an online booking tool (OBT) and a mobile application.

In one embodiment, the system 100 is programmed to publish a public “Start A Trip” API endpoint and share it with customers. In an embodiment, the system 100 is programmed to publish a publicly available “Start A Trip” Zap for our customers to use, accompanied by an API endpoint.

In an embodiment, a travel manager can incorporate automatic trip creation into business workflows so that travelers save time and custom fields related to changing the travel segments, origin, destination, accommodations, event data, and venue name and city can be passed to reduce human error.

### 2.2 Start a Trip Architecture Decisions

In an example, a trip is started in an empty state with only a trip name. This trip has no concept of when the trip may be taken, what the intended origin or destination is, or what inventory is desired. Generally, the trip may include only a name of origin and destination. Because trips are formed in such an empty state, completing searches on the trips can become repetitive. Travelers who do not complete booking information with respect to the trip immediately and abandon the search will have to repeat adding the search criteria when they return to complete the search, as the booking information that was previously entered is not stored. Sometimes, the booking information may be difficult to understand for the intended trip. Thus, embodiments provide a solution by storing this booking information to implement future product expansion with intelligent search suggestions relevant to a trip or a traveler's preferences.

2.2.a. Stories Included in Start a Trip

Embodiments use the system 100 to start a trip and quickly search and view flights and hotels to book for a traveler. The system 100 searches and books the flights and hotels that match the traveler's input data, including original, destination, and travel date and time.

2.2.b. Architecture Discussion

After the traveler inputs data corresponding to where the traveler needs to go and when the traveler wishes to travel, this data is stored in database 130 to use later to run a new search to make searching for flight and hotel options that correspond to the input data previously entered. The data includes a structure for storing a traveler's intent to do something like booking a flight or hotel. In some embodiments, traveler intents are inventory-specific. The traveler's intent may include a flight booking intent and a hotel booking intent. The flight intent suggests that the traveler intends to book a flight from point (origin) A to point (destination) B. The hotel intent suggests that the traveler wants to book a hotel in location when the travel reaches the destination. When the traveler fills out the start a trip form, the traveler only mentions where and when the traveler needs to be present and does not indicate the modes of transport and when the traveler wants to book the modes and schedule of transport.

In an embodiment, database 130 includes a data structure, for example, a “Waypoint”. The data structure “Waypoint” comprises a many-to-one relationship with a trip. In an embodiment, the “Waypoint” stores a location (where the traveler needs to be) and two timestamps (when the traveler needs to be in that location and when they need to leave). Using this structure allows modifying a traveler's graphics interchange format (GIF) back-end to also use waypoints to make the data structure of guest traveler trips simpler later.

2.2.c. Limited Traveler Trip Stops Testing Flow

In an embodiment, some travel passes for the team of employees/travelers may be required to be created.

At the first step, a travel manager, a trip scheduler, or a user with an admin role logs out of the system and accesses the server using the link “https://domain.server.com/travel-pass?” with a nonce to create travel passes. The traveler or travel manager fills out a form for a single trip to create travel pass selections for a single location. In an embodiment, multiple trips functionality may be implemented to create multi-trip travel pass selections for multiple locations. For multi-trip, embodiments may utilize sequential query language (SQL) inputs to add destinations to travel passes that may include multi-cities in the trip. While booking the travel passes, the travel manager may include the email of the user with an admin role who belongs to the Hogwarts team, and a request to book the travel passes is submitted with one email address or email information of the user or the travel manager. For example, a super-admin or the user with the admin role is not put on another team. In this way, one user may create a single set of travel passes at one time and cannot use the same email information again to create multiple travel passes. The travel manager needs to use another email address or change the email address and then create another set of travel passes.

In the second step, the travel passes are approved by the travel manager when the travel manager logs in as an admin for which the travel manager entered as the admin in the previous (first) step.

In the third step, a traveler logs in as one of the users (travelers) for whom the travel passes are created. The travel can create a round trip or one-way trip and may enter trip stops where the destination is chosen as one of the places in the travel pass. The traveler and/or the travel manager may verify the travel pass and may change the destination to a different place. The traveler may be notified with an alert by displaying an alert box if the travel pass disappears upon travel pass verification. The traveler may change the destination that was entered previously and verify the change that cannot be performed without selecting a travel pass. The traveler may select the travel pass and may proceed through the rest of the booking process/flow to finish creating the trip stops. In an embodiment, the traveler may start another trip to the same location/destination and verify that there are no travel passes available or selected for the trip. After completing the booking process, a new travel pass may be created for another trip.

### 2.3 Top Picks Based on Traveler Prior Bookings and Traveler Priority

In an embodiment, system 100 can surface ideal flight and hotel options at the top of a traveler's search to make it fast to book flights and hotels based on prior bookings or the history of the traveler's travels or trips. The top picks of flights and hotels may be performed based on one or more factors. The factors may include an ability to collect the traveler's preferences, performing a function of a basic sorting algorithm that weighs the traveler's preferences, reporting measures associated with the output of the sorting algorithm, and a feedback mechanism that helps understand why travelers didn't select the suggestions/recommendations in the previous booking process. This way, the sorting algorithm may learn and update itself to correspond with one or more factors of the previous bookings and employ the traveler's preferences in a travel program of the system 100.

### 2.3.A. Success Criteria

In an embodiment, the travelers can indicate features of flights and hotels preferable to them. Those preferences are used to recommend top picks or top options to the travelers and sort the remaining options when the travelers search for flights and hotels. For example, the traveler preferences are weighted to compute weight values against price so that the suggestions or recommendations do not include $2000 flights on their preferred airline when there are $200 alternatives available. These weight values of traveler preferences may serve as a basis to build on other factors that the external travel data server 120 and 122 (employer/company of the traveler) may use in future iterations, such as contract fulfillment or environmental impact. During a search, the travelers may be provided with an explanation of how and why the top picks or options or suggestions/recommendations are selected based on the traveler preferences and/or weight value of the traveler preferences. In one embodiment, system 100 may mitigate risks by putting wireframes in front of the users (travelers/candidates) and pilot candidates to collect feedback. In an embodiment, members of the system 100 may measure how often top options are being selected by the traveler(s). In an embodiment, the members of the system 100 may measure how long it takes the travelers to select a flight or hotel after beginning a search. In an embodiment, a plurality of metrics may be measured to determine success criteria for recommending the top picks or top options to travelers.

For example, the plurality of metrics may include but are not limited to, average time to book, average ranking of selected flight/hotel booking, and percentage of the booked flight/hotel from the top picks versus other recommended options. Each of the plurality of metrics may depend on segmentations of recommendations that are provided according to the traveler, team, city pair (flights), and city/venue of the destination point (hotels). The average time to book is a metric to measure whether the speed and time at which travelers making reservations or bookings are increasing or decreasing. The average ranking of selected flight/hotel booking is a metric to measure how successfully the filtering options provide the top picks and recommendations for the traveler. The percentage (%) of the booked flight/hotel from the top picks versus other recommended options is a metric to measure the “hit rate” of top recommendations. The plurality of metrics are applied to meet key priorities of enterprise travel programs.

For example, the key priorities of travel programs may include traveler efficiency, traveler quality of life, and cost containment/savings. In general, existing tools provide “clunky” and “outdated” UI/UX (user experience). Also, existing platforms associated with online booking tools (OBT) unintelligently display every available flight or hotel, resulting in a “paradox of choice” for the traveler and requiring them to weed through hundreds of sub-optimal options to find their selection. Furthermore, corporate travel differs from almost everything else that a company buys in that individual travelers are able to make trade-off decisions between the various qualitative attributes of the options they are selecting. Thus, embodiments weigh various factors such as convenience, quality, and price for the traveler to make the selection among the recommendations/top picks. Such a way of weighing and classifying the recommendations based on the key priorities may solve the lag faced while booking. Also, the amount of time to complete a booking is reduced.

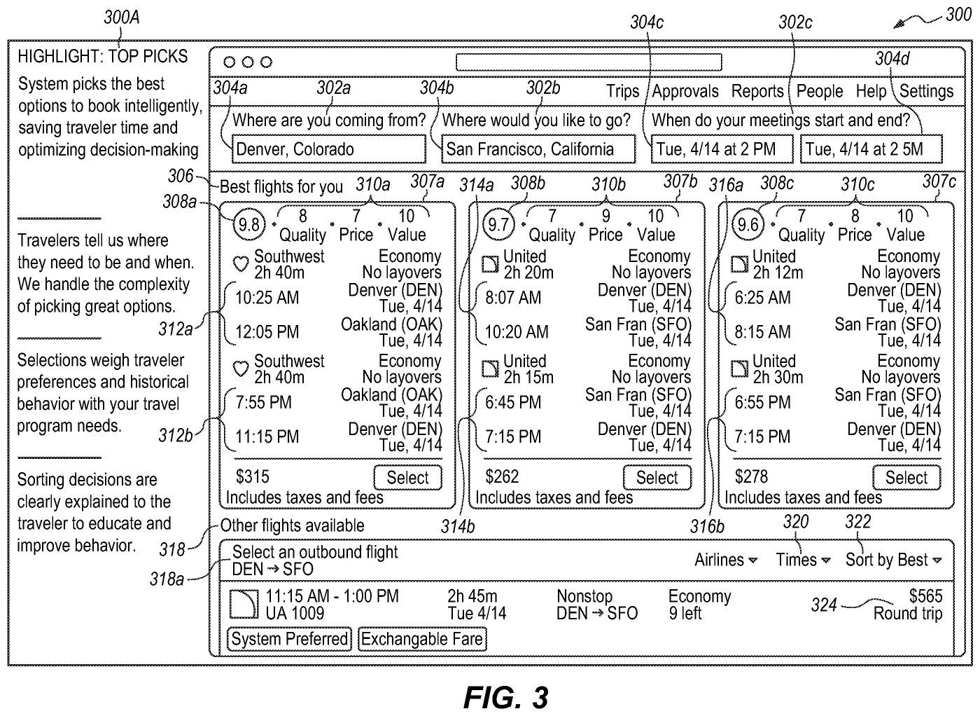

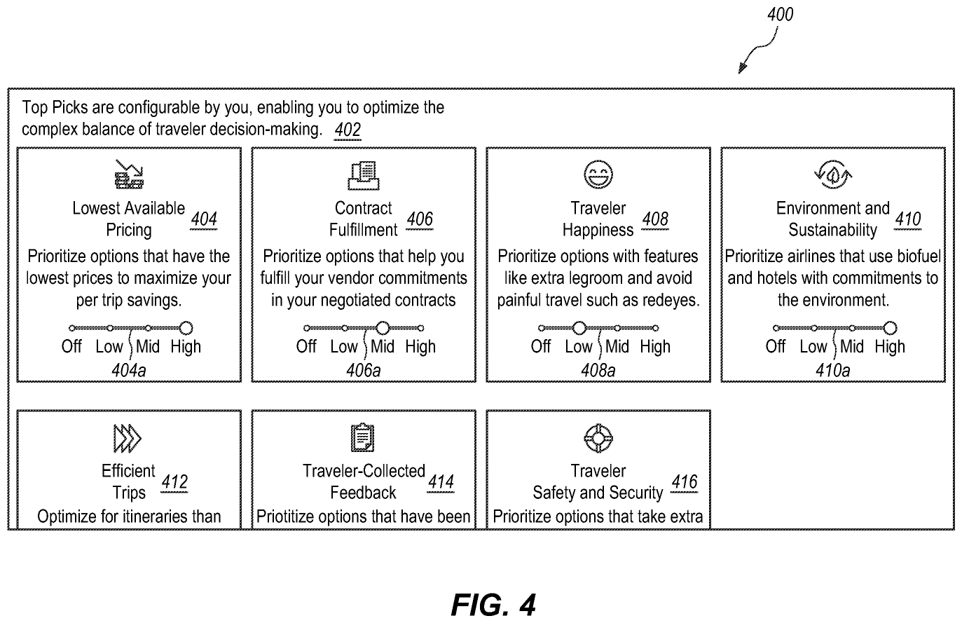

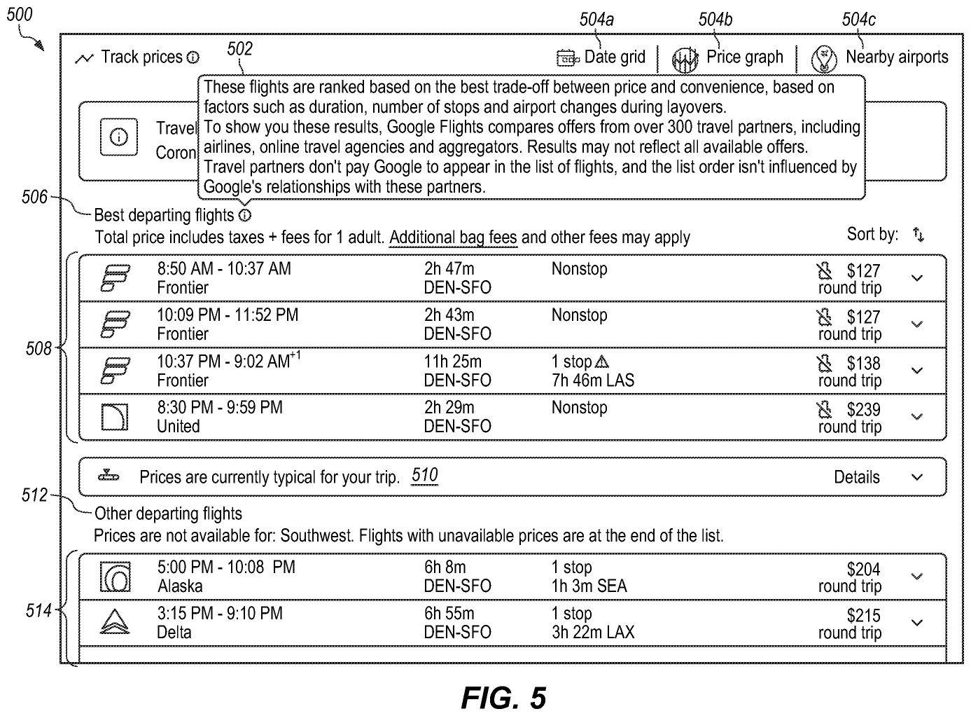

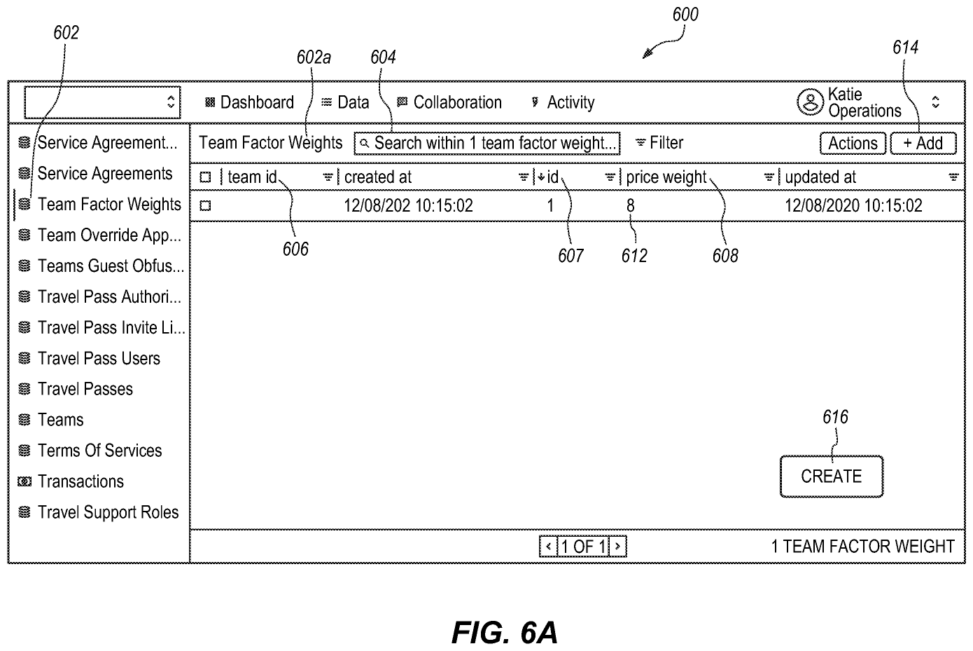

FIG. 3 illustrates an example of a graphical user interface (GUI) 300 with options of top pick and recommendations of flights 300A, according to an embodiment. The GUI 300 may be associated with a computer device of a traveler or a travel manager or an admin booking the trip for the traveler. For example, GUI 300 displays one or more input trip fields 302a, 302b, and 302c to receive trip input data (304a, 304b, 304c, and 304d) from the traveler or travel manager booking the trip. The input trip fields may require the traveler to specify the origin of trip 302a under the field “Where are you coming from?”, the destination of trip 302c under the field “Where would you like to go?” and the timestamp/period of a meeting 302c under the field “When do your meetings start and end?”. The traveler may provide details of the meetings in text fields 304a, 304b, 304c, and 304d as the input data. For example, the traveler may specify “Denver, Colorado” as the origin 304a, “San Francisco, California” as the destination 304b, and the timestamp of the meeting, including the start of the meeting on Tuesday, April 2014 at 2 PM in the field 304c and end of the meeting on the same day Tuesday April 2014 at 5 PM in field 304d.

Based on the input data from each field (304a, 304b, 304c, and 304d), the SaaS-based travel and expense application 106 searches in various travel databases associated with external travel data servers 120 and 122 to pick and provide best flights 306 options according to traveler's preferences. In this example, the external travel data servers 102 and 122 may correspond to “Southwest” and “United” airlines. In one embodiment, the search for the best flight 306 options may correspond to the preference of the application 106. The best flight 306 options may display a list of flights for a round trip of the traveler having the timings of the flights before the start of the meeting in field 304c and after the end of the meeting in field 304d.

For example, the best flights 306 options provides three round-trip options 307a, 307b, and 307c. The trip option 307a contains round trip options 312a from the start point to the destination point and 312b from the destination point back to the start point, corresponding to the origin and destination fields 304a and 304b. Also, the timing of flight option 312a from the start point to the destination point is according to the meeting start time from field 304c. Similarly, the timing of flight option 312b from the destination point to the origin point is according to the meeting end time from field 304d. Similarly, trip options 307b and 307c contain flight options 314a and 316a (from the start point to the destination point) with flight options 314b and 316b (from the destination point back to the start point), corresponding to the origin and destination fields 304a and 304b. Also, the timing of flight options 314a and 316a from the start point to the destination point is according to the time specified from field 304c of the meeting start time. Similarly, the timing of the round-trip options 314b and 316b from the destination point is according to the time specified from the field 304d of the meeting ending time. Each of the trip options 307a, 307b, and 307c contain ratings 308a, 308b, and 308c, respectively defining the overall ratings. The ratings 308a, 308b, and 308c of each trip option 307a, 307b, and 307c may be based on the flight travel, and factors 310a, 310b, and 310c associated with the quality of the travel, pricing of the trip options and value of the trip. The GUI 300 and under the top picks of flights 300A, other flight options 318 that are available are displayed. For example, under flight option 300A, an outbound flight 318a for a round trip 324 may be displayed as one of the best options that may be according to the timestamp from the fields 304c and 304d of the meeting. The other flights 318 that are available may be sorted in the list according to times 320 and best available as per their ratings and the factors of the quality, value, and pricing. GUI 300 displays the best options to book intelligently which saves traveler time in searching for the best flight options and optimize the decision-making of the traveler for choosing the best flights out of the options 307a, 307b, 307c, and 318.

In an embodiment, GUI 300 may display top picks and recommendations of flights 300A by using a machine learning library. For example, an AWS personalized library and/or Google artificial intelligence (AI) recommendations that generate recommendations for travelers based on their past travel behaviors and booking patterns. In an embodiment, the recommendations of flights 300A and accommodations may be revealed as preferences that are learned and updated to the machine learning library based on the traveler's travel behaviors and booking patterns. In an embodiment, the machine learning library may be updated, and the machine learning library may be utilized to provide recommendations for flights 300A and accommodations based on feeds and updates corresponding to the traveler's social networking account. In an embodiment, GUI 300 may display recommendations of flights 300A and accommodations based on the traveler's or travel manager's priorities, from FIG. 4 and/or a combination of machine learning-based recommendations and traveler's/travel manager's priorities.

FIG. 4 illustrates a GUI 400 with prioritizing options to optimize traveler decision-making of choosing the best flights and accommodations options, according to an embodiment. In an embodiment, the travel database search query (queries) may be executed or run based on application of optimizing options or prioritizing options. The GUI 400 various optimizing options based on traveler preference for travel or trip. For example, GUI 400 displays the optimizing options 402 for configuring the top picks of trip options that may enhance traveler's decision-making of flights and accommodations choices.

The optimizing options 402 may include but are not limited to lowest available pricing 404, contract fulfillment 406, traveler happiness 408, environment and sustainability 410, efficient trips 412, traveler-collected feedback 414, and traveler safety and security 416. The lowest available pricing 404 may be associated with the pricing information of the airlines and accommodation. The available airline/accommodation may be sorted, prioritized, and displayed for the traveler's selection based on the lowest to highest pricing, with the lowest pricing option being at the top of the list of trip options. This way of prioritizing the lowest pricing available option improves traveler's per-trip savings. Contract fulfillment 406 may be associated with sorting and prioritizing the trip options according to the company's contract with airlines and/or accommodation-approved contracts. For example, contract fulfillment 406 prioritizes the trip options that improve the fulfillment of vendor commitments in the negotiated contracts.

Traveler happiness 408 may account for the traveler's comfort, ratings, and satisfaction with booking the flights and accommodations. For example, traveler happiness 408 sorts and prioritizes the trip options according to the features, such as extra legroom and avoiding painful travel, such as redeyes. Environment and sustainability 410 prioritizes airlines that use biofuel and hotels with commitments to the environment. Efficient trips 412 may be associated with optimizing itineraries of the trip options based on the number of overlays, number of stopovers, quality of travel, cost containment/savings, policy of flights and hotels, time for completing the travel from the source point to the destination point. Traveler-collected feedback 414 may include the trip options that are prioritized according to the traveler feedback in the previous trips. Traveler safety and security 416 prioritizes flights and hotels based on extra safety and security factors for the traveler's travel.

In an embodiment, each of the optimizing options 402 may be associated with an optimizing scale (404a, 406a, 408a, 410a, 412a, 414a and 416a). The optimizing scale 404a, 406a, 408a, 410a, 412a, 414a, and 416a corresponding to each optimizing option (404, 406, 408, 410, 412, 414, and 416) can be set to any of the scaling factors “off”, “low”, medium (“mid”) and “high”. The search and prioritization of flights and hotels is performed according to the scaling factors. For example, if the scaling factor is set to “high” mode 404a in the lowest available pricing 404, the search and prioritization of the trip option is performed that lists the trip options according to the lowest pricing of the flights and hotels. If the scaling factor is set to “low” mode 408a for traveler happiness 408, then the traveler happiness is considered as the lowest priority while prioritizing the trip options. In some examples, the traveler may weigh traveler happiness as high versus cost savings as low, resulting in recommendations that prioritize the quality of the inventory over its price. In an embodiment, each of the optimizing options (404, 408, 410, 412, 414, and 416) may be considered as an expressed preference that is learned based on more bookings, and thus the expressed preference may be considered as a revealed preference.

In an embodiment, each optimizing option (404, 406, 408, 410, 412, 414, and 416) represents factors for top picks of the trip options. In an embodiment, each optimizing option may be a vector of preference expressed by the traveler, for example, showing the importance of flying a preferred or particular airline. In an embodiment, the optimizing options (404, 406, 408, 410, 412, 414, and 416) may be a first set of preferences expressed by the travel manager, for example, indicating the importance of price or the preference of staying at hotels in the company's preferred list of accommodations. In an embodiment, the preference may be measured in terms of a number on a finite optimizing scale 404a, 406a, 408a, 410a, 412a, 414a, and 416a. In the MVP, each of the optimizing options (404, 406, 408, 410, 412, 414, and 416) from the traveler may be weighed against price or compared with the price to provide the best recommendations of commute and accommodation options that are approved by the company policy.

In some embodiments, the travel manager(s) may utilize an interface to configure the relative importance or preference of the optimizing options (404, 406, 408, 410, 412, 414, and 416) in performing the flight and hotel search results. In an embodiment, other optimizing options may be provided for setting a second set of preferences for the flight search results. The second set of preferences may represent a piece of information unique to the specific domain of a given factor and thus, the second set of preferences may be used to calculate a score for a given flight against the factor. For example, if a factor is “flying a preferred airline”, a preference associated with that factor for a given traveler is the actual preferred airline list, for example, Delta and United preferred by the traveler. As another example, the traveler may prefer a time as 7 AM, 8 AM, etc., as early if the traveler's preference is to avoid early departure. If a travel manager prefers contract fulfillment 406 that may correspond to a company's contracted minimums with hotels, the preferences associated with that factor may provide a list of hotels that the company has a contract with and the number of room nights that the company needs to do with those hotels to meet their contracts. In an embodiment, each of the flight or hotel options chosen by the traveler or travel manager is scored, and the overall score may be combined for the given flight or hotel option. For example, each of the optimizing options (404, 406, 408, 410, 412, 414, and 416) may be a factor, and scoring the factor may be considered as “factor score”. In an embodiment, the overall score may be computed from the combination of all “factor scores” with their relevant weights/scores. The overall score determines the order that the recommendation option or top pick appears in the search results. For example, the overall score may be computed using technique of order preference similarity to the ideal solution (TOPSIS). The overall score may be computed as:

$$\\ score = ( factor\_c \_score * weight\_a ) + ( factor\_b \_score * weight\_b ) + ( factor\_c \_score * weight\_c ) + ( factor\_d \_score * weight\_d )$$

In an embodiment, each factor score and/or the overall score may be utilized for future search operations of commute and accommodation options. In some embodiments, the recommendation option or the top picks are scored to determine a best sort order for flight/air and hotel search results, to determine recommendations for SI automation and to automatically pick a hotel for a guest traveler. In an embodiment, SI automation is scored differently than the travel agent'/manager's flights and hotel search. For example, SI automation is scored based on combinations of outbound and return whereas the agent's flight/hotel search is scored based on agent's preference independently, for example, each leg room. For SI automation, event conflicts and policy related flights are pulled out. The SI automation removes outbound duplicates in the pairing of recommendation options or the top picks to create more diversity of recommendation options. For example, the departing time between 11 PM and 6 AM may not be taken as input based on the flight start time and for other travelers departing options may include option of departing the day before or day of the event. In an embodiment, an average delta (A) from a launch and landing facility (LLF) is measured for a travel manager as a counterbalancing metrics. For example, a travel manager may have ALLF (average LLF) in the top 10^{th} percentile but a time to book in the bottom 50^{th} percentile suggesting that their weight of LLF is too aggressive. Some algorithms, for example, multi-criteria decision support models are utilized to determine travel manager's percentiles and decisions.

FIG. 5 illustrates an example GUI displaying the best top picks of flights, according to an embodiment. In an embodiment, the top picks of flights and accommodations are displayed in any form of date grid 504a and price graph 504b. GUI 500 may also provide a list of nearby airports 504c. For example, GUI 500 displays the best departing flight 506 with various flight options 508. In an embodiment, GUI 500 displays flights that are ranked based on the best trade-off between price and convenience 502. The best trade-off between the pricing and the convenience depends on duration, number of stops, and airport changes during layovers. For example, flight prices are compared with offers from over 300 travel partners, including airlines, online travel agencies, and aggregators. In an embodiment, the best top picks 506 with various flight options 508 are displayed if the pricing is prioritized and plays a crucial factor in listing the best top picks for the trip, as shown in 510, where the prices are currently typical for the traveler's trip. GUI 500 may display other departing flights 512 also that may not consider the prices as the factor in listing various flight options 514.

FIG. 6A and FIG. 6B illustrate examples of a GUI for setting weights, according to an embodiment. FIG. 6A shows an example of GUI 600 displaying fields for travelers to use preferences and weights as input score values in flight search results. In particular, GUI 600 may allow travel managers to set preferences and weights for their team to determine the relative influence of those team factors against the travelers. In an embodiment, the flight search results are similar to the top picks 300A from FIG. 3. The flight search results may be further prioritized based on the input score values from the travelers. In an embodiment, the travel managers determine the weight value as the input score values on a scale of “1” to “10”, with 10 being the most important. A weight value of “0” means that the input score values corresponding to the preferences and weights may not be considered to score the flights in the flight search results. FIG. 6A shows an example of applying cost or price weight 608 as a factor to score the flights in the flight search results. In an embodiment, the cost or price may be given as one factor for prioritizing the flight search results. To apply a team's preferred weight 602a to the price weight factor 608 (cost factor), a table “Team Factor Weights” 602 in Forest is opened. GUI 600 allows the travel manager to input team factor weights 602a in a field 604 to search the flights within one team factor weight. The “add” button 614 is clicked to add the team factor weights 602a. Upon clicking the “add” button 614, the fields “team id” 606, “id” 607, and “price weight” 608 are displayed. In the “team id” 606, the ID name/number of the team may be entered as “Pana” 610. In an embodiment, the team's number/name may be searched in the team's table in the travel database 130. In the “price weight” field, a value ranging from 1 to 10 may be entered. For example, the travel manager may enter the value of “price weight” as “8” 612. The travel manager may click on the “create” button 616 to apply the “price weight” 612 to all the flight search results for the team under “Pana” 610 with the “team id” 606. Referring to FIG. 6B, the travel manager may create a new team id 618 under “team id” 606 field. In some examples, the “price weight” 612 may be set to “0” 620 so that the flight search results are prioritized by not considering the “price weight” 612.

### 3. Implementation Example—Hardware Overview

According to one embodiment, the techniques described herein are implemented by at least one computing device. The techniques may be implemented in whole or in part using a combination of at least one server computer and/or other computing devices that are coupled using a network, such as a packet data network. The computing devices may be hard-wired to perform the techniques or may include digital electronic devices such as at least one application-specific integrated circuit (ASIC) or field programmable gate array (FPGA) that is persistently programmed to perform the techniques or may include at least one general purpose hardware processor programmed to perform the techniques pursuant to program instructions in firmware, memory, other storage, or a combination. Such computing devices may also combine custom hard-wired logic, ASICs, or FPGAs with custom programming to accomplish the described techniques. The computing devices may be server computers, workstations, personal computers, portable computer systems, handheld devices, mobile computing devices, wearable devices, body-mounted or implantable devices, smartphones, smart appliances, internetworking devices, autonomous or semi-autonomous devices such as robots or unmanned ground or aerial vehicles, any other electronic device that incorporates hard-wired and/or program logic to implement the described techniques, one or more virtual computing machines or instances in a data center, and/or a network of server computers and/or personal computers.

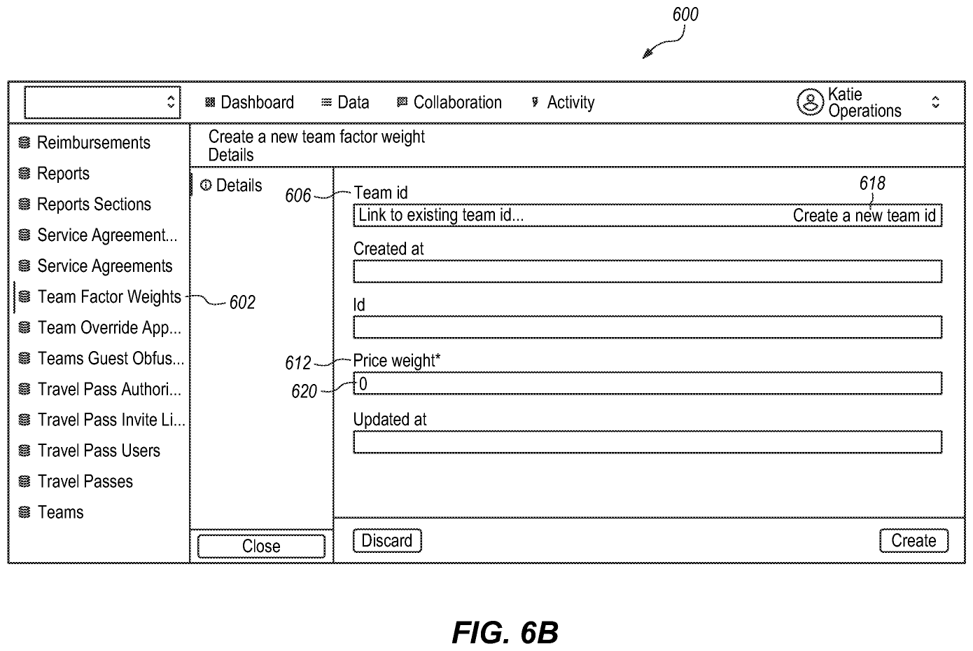

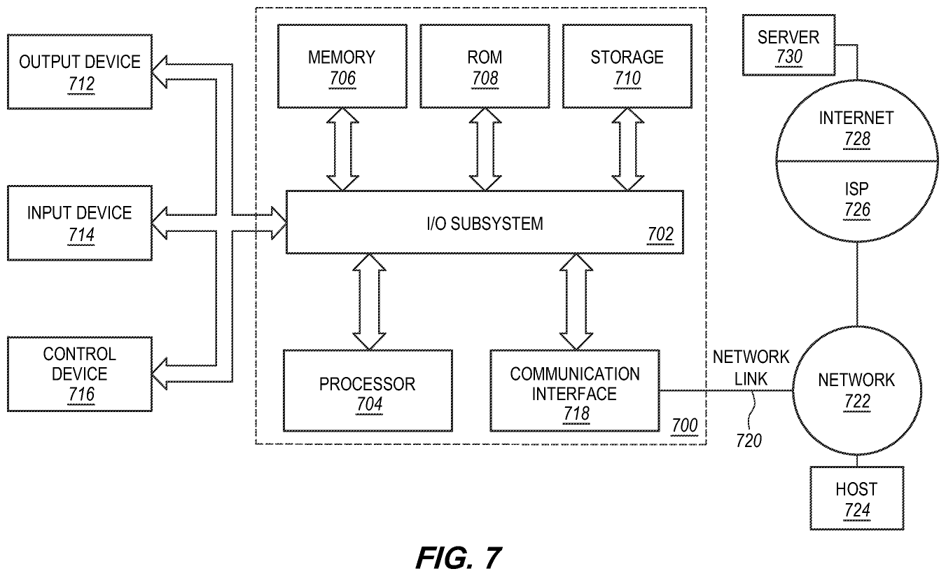

FIG. 7 is a block diagram that illustrates an example computer system with which an embodiment may be implemented. In the example of FIG. 7, a computer system 700 and instructions for implementing the disclosed technologies in hardware, software, or a combination of hardware and software, are represented schematically, for example, as boxes and circles, at the same level of detail that is commonly used by persons of ordinary skill in the art to which this disclosure pertains for communicating about computer architecture and computer systems implementations.

Computer system 700 includes an input/output (I/O) subsystem 702, which may include a bus and/or other communication mechanism(s) for communicating information and/or instructions between the components of the computer system 700 over electronic signal paths. The I/O subsystem 702 may include an I/O controller, a memory controller, and at least one I/O port. The electronic signal paths are represented schematically in the drawings, such as lines, unidirectional arrows, or bidirectional arrows.

At least one hardware processor 704 is coupled to I/O subsystem 702 for processing information and instructions. Hardware processor 704 may include, for example, a general-purpose microprocessor or microcontroller and/or a special-purpose microprocessor such as an embedded system, a graphics processing unit (GPU), or a digital signal processor or ARM processor. Processor 704 may comprise an integrated arithmetic logic unit (ALU) or may be coupled to a separate ALU.

Computer system 700 includes one or more units of memory 706, such as a main memory, which is coupled to I/O subsystem 702 for electronically digitally storing data and instructions to be executed by processor 704. Memory 706 may include volatile memory such as various forms of random-access memory (RAM) or other dynamic storage device. Memory 706 may also be used for storing temporary variables or other intermediate information during the execution of instructions to be executed by processor 704. Such instructions, when stored in non-transitory computer-readable storage media accessible to processor 704, can render computer system 700 into a special-purpose machine that is customized to perform the operations specified in the instructions.

Computer system 700 further includes non-volatile memory such as read-only memory (ROM) 708 or other static storage devices coupled to I/O subsystem 702 for storing information and instructions for processor 704. The ROM 708 may include various forms of programmable ROM (PROM) such as erasable PROM (EPROM) or electrically erasable PROM (EEPROM). A unit of persistent storage 710 may include various forms of non-volatile RAM (NVRAM), such as FLASH memory, or solid-state storage, magnetic disk or optical disk such as CD-ROM or DVD-ROM and may be coupled to I/O subsystem 702 for storing information and instructions. Storage 710 is an example of a non-transitory computer-readable medium that may be used to store instructions and data, which, when executed by the processor 704, causes performing computer-implemented methods to execute the techniques herein.

The instructions in memory 706, ROM 708, or storage 710 may comprise one or more sets of instructions that are organized as modules, methods, objects, functions, routines, or calls. The instructions may be organized as one or more computer programs, operating system services, or application programs, including mobile apps. The instructions may comprise an operating system and/or system software; one or more libraries to support multimedia, programming, or other functions; data protocol instructions or stacks to implement TCP/IP, HTTP or other communication protocols; file format processing instructions to parse or render files coded using HTML, XML, JPEG, MPEG or PNG; user interface instructions to render or interpret commands for a graphical user interface (GUI), command-line interface or text user interface; application software such as an office suite, internet access applications, design and manufacturing applications, graphics applications, audio applications, software engineering applications, educational applications, games or miscellaneous applications. The instructions may implement a web server, web application server, or web client. The instructions may be organized as a presentation layer, application layer, and data storage layer, such as a relational database system using structured query language (SQL) or no SQL, an object store, a graph database, a flat file system, or other data storage.

Computer system 700 may be coupled via I/O subsystem 702 to at least one output device 712. In one embodiment, output device 712 is a digital computer display. Examples of a display that may be used in various embodiments include a touchscreen display, a light-emitting diode (LED) display, a liquid crystal display (LCD) or an e-paper display. Computer system 700 may include other type(s) of output devices 712, alternatively or in addition to a display device. Examples of other output devices 712 include printers, ticket printers, plotters, projectors, sound cards or video cards, speakers, buzzers or piezoelectric devices or other audible devices, lamps or LED or LCD indicators, haptic devices, actuators or servos.

At least one input device 714 is coupled to I/O subsystem 702 for communicating signals, data, command selections, or gestures to processor 704. Examples of input devices 714 include touch screens, microphones, still and video digital cameras, alphanumeric and other keys, keypads, keyboards, graphics tablets, image scanners, joysticks, clocks, switches, buttons, dials, slides, and/or various types of sensors such as force sensors, motion sensors, heat sensors, accelerometers, gyroscopes, and inertial measurement unit (IMU) sensors and/or various types of transceivers such as wireless, such as cellular or Wi-Fi, radio frequency (RF) or infrared (IR) transceivers and Global Positioning System (GPS) transceivers.

Another type of input device is a control device 716, which may perform cursor control or other automated control functions such as navigation in a graphical interface on a display screen, alternatively or in addition to input functions. Control device 716 may be a touchpad, a mouse, a trackball, or cursor direction keys for communicating direction information and command selections to processor 704 and for controlling cursor movement on an output device 712, such as a display. The input device may have at least two degrees of freedom in two axes, a first axis (e.g., x) and a second axis (e.g., y), that allows the device to specify positions in a plane. Another type of input device is a wired, wireless, or optical control device such as a joystick, wand, console, steering wheel, pedal, gearshift mechanism, or other type of control device. An input device 714 may include a combination of multiple different input devices, such as a video camera and a depth sensor.

In another embodiment, computer system 700 may comprise an Internet of Things (IoT) device in which one or more of the output device 712, input device 714, and control device 716 are omitted. Or, in such an embodiment, the input device 714 may comprise one or more cameras, motion detectors, thermometers, microphones, seismic detectors, other sensors or detectors, measurement devices or encoders, and the output device 712 may comprise a special-purpose display such as a single-line LED or LCD display, one or more indicators, a display panel, a meter, a valve, a solenoid, an actuator or a servo.

When computer system 700 is a mobile computing device, input device 714 may comprise a global positioning system (GPS) receiver coupled to a GPS module that is capable of triangulating to a plurality of GPS satellites, determining and generating geo-location or position data such as latitude-longitude values for a geophysical location of the computer system 700. Output device 712 may include hardware, software, firmware, and interfaces for generating position reporting packets, notifications, pulse or heartbeat signals, or other recurring data transmissions that specify a position of the computer system 700, alone or in combination with other application-specific data, directed toward host computer 724 or server computer 730.

Computer system 700 may implement the techniques described herein using customized hard-wired logic, at least one ASIC or FPGA, firmware and/or program instructions or logic which, when loaded and used or executed in combination with the computer system, causes or programs the computer system to operate as a special-purpose machine. According to one embodiment, the techniques herein are performed by computer system 700 in response to processor 704 executing at least one sequence of at least one instruction contained in main memory 706. Such instructions may be read into main memory 706 from another storage medium, such as storage 710. Execution of the sequences of instructions contained in main memory 706 causes processor 704 to perform the process steps described herein. In alternative embodiments, hard-wired circuitry may be used in place of or in combination with software instructions.

The term “storage media,” as used herein, refers to any non-transitory media that store data and/or instructions that cause a machine to operate in a specific fashion. Such storage media may comprise non-volatile media and/or volatile media. Non-volatile media includes, for example, optical or magnetic disks, such as storage 710. Volatile media includes dynamic memory, such as memory 706. Common forms of storage media include, for example, a hard disk, solid state drive, flash drive, magnetic data storage medium, any optical or physical data storage medium, memory chip, or the like.

Storage media is distinct from but may be used in conjunction with transmission media. Transmission media participates in transferring information between storage media. For example, transmission media includes coaxial cables, copper wire, and fiber optics, including the wires that comprise a bus of I/O subsystem 702. Transmission media can also take the form of acoustic or light waves, such as those generated during radio-wave and infrared data communications.

Various forms of media may be involved in carrying at least one sequence of at least one instruction to processor 704 for execution. For example, the instructions may initially be carried on a magnetic disk or solid-state drive of a remote computer. The remote computer can load the instructions into its dynamic memory and send the instructions over a communication link such as a fiber optic or coaxial cable or telephone line using a modem. A modem or router local to computer system 700 can receive the data on the communication link and convert the data to a format that can be read by computer system 700. For instance, a receiver such as a radio frequency antenna or an infrared detector can receive the data carried in a wireless or optical signal, and appropriate circuitry can provide the data to I/O subsystem 702, such as placing the data on a bus. I/O subsystem 702 carries the data to memory 706, from which processor 704 retrieves and executes the instructions. The instructions received by memory 706 may optionally be stored on storage 710 either before or after execution by processor 704.

Computer system 700 also includes a communication interface 718 coupled to I/O subsystem 702. Communication interface 718 provides a two-way data communication coupling to network link(s) 720 that are directly or indirectly connected to at least one communication network, such as a network 722 or a public or private cloud on the Internet. For example, communication interface 718 may be an Ethernet networking interface, integrated-services digital network (ISDN) card, cable modem, satellite modem, or a modem to provide a data communication connection to a corresponding type of communications line, for example, an Ethernet cable or a metal cable of any kind or a fiber-optic line or a telephone line. Network 722 broadly represents a local area network (LAN), wide-area network (WAN), campus network, internetwork, or any combination thereof. Communication interface 718 may comprise a LAN card to provide a data communication connection to a compatible LAN, a cellular radiotelephone interface that is wired to send or receive cellular data according to cellular radiotelephone wireless networking standards, or a satellite radio interface that is wired to send or receive digital data according to satellite wireless networking standards. In any such implementation, communication interface 718 sends and receives electrical, electromagnetic, or optical signals over signal paths that carry digital data streams representing various types of information.

Network link 720 typically provides electrical, electromagnetic, or optical data communication directly or through at least one network to other data devices, using, for example, satellite, cellular, Wi-Fi, or BLUETOOTH technology. For example, network link 720 may provide a connection through network 722 to a host computer 724.

Furthermore, network link 720 may provide a connection through network 722 or to other computing devices via internetworking devices and/or computers that are operated by an Internet Service Provider (ISP) 726. ISP 726 provides data communication services through a worldwide packet data communication network represented as Internet 728. A server computer 730 may be coupled to Internet 728. Server computer 730 broadly represents any computer, data center, virtual machine, or virtual computing instance with or without a hypervisor or computer executing a containerized program system such as DOCKER or KUBERNETES. Server computer 730 may represent an electronic digital service that is implemented using more than one computer or instance, and that is accessed and used by transmitting web services requests, uniform resource locator (URL) strings with parameters in HTTP payloads, API calls, app services calls, or other service calls. Computer system 700 and server computer 730 may form elements of a distributed computing system that includes other computers, a processing cluster, a server farm, or other organization of computers that cooperate to perform tasks or execute applications or services. Server computer 730 may comprise one or more sets of instructions that are organized as modules, methods, objects, functions, routines, or calls. The instructions may be organized as one or more computer programs, operating system services, or application programs, including mobile apps. The instructions may comprise an operating system and/or system software; one or more libraries to support multimedia, programming, or other functions; data protocol instructions or stacks to implement TCP/IP, HTTP or other communication protocols; file format processing instructions to parse or render files coded using HTML, XML, JPEG, MPEG or PNG; user interface instructions to render or interpret commands for a graphical user interface (GUI), command-line interface or text user interface; application software such as an office suite, internet access applications, design and manufacturing applications, graphics applications, audio applications, software engineering applications, educational applications, games or miscellaneous applications. Server computer 730 may comprise a web application server that hosts a presentation layer, application layer, and data storage layer such as a relational database system using structured query language (SQL) or no SQL, an object store, a graph database, a flat file system, or other data storage.

Computer system 700 can send messages and receive data and instructions, including program code, through the network(s), network link 720, and communication interface 718. In the Internet example, server computer 730 might transmit a requested code for an application program through Internet 728, ISP 726, local network 722, and communication interface 718. The received code may be executed by processor 704 as it is received and/or stored in storage 710 or other non-volatile storage for later execution.

The execution of instructions, as described in this section, may implement a process in the form of an instance of a computer program that is being executed and consists of a program code and its current activity. Depending on the operating system (OS), a process may be made up of multiple threads of execution that execute instructions concurrently. In this context, a computer program is a passive collection of instructions, while a process may be the actual execution of those instructions. Several processes may be associated with the same program; for example, opening up several instances of the same program often means more than one process is being executed. Multitasking may be implemented to allow multiple processes to share processor 704. While each processor 704 or core of the processor executes a single task at a time, computer system 700 may be programmed to implement multitasking to allow each processor to switch between tasks that are being executed without having to wait for each task to finish. In an embodiment, switches may be performed when tasks perform input/output operations when a task indicates that it can be switched or on hardware interrupts. Time-sharing may be implemented to allow fast response for interactive user applications by rapidly performing context switches to provide the appearance of concurrent execution of multiple processes simultaneously. In an embodiment, for security and reliability, an operating system may prevent direct communication between independent processes, providing strictly mediated and controlled inter-process communication functionality.

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

What is claimed is:

1. A computer-implemented method comprising:
using a travel and expense application, receiving trip input data comprising an origin of travel, a destination of the travel, and a period of an event from a web-based application implemented in a computing device of a candidate, the trip input data associated with an event record having an event identifier of the event;
using the travel and expense application, populating a plurality of trip fields of a travel database comprising a plurality of trip database records with the event identifier associated with the trip input data to automatically create and store a trip record for a new trip of the candidate, the travel database is communicatively coupled to the travel and expense application;
using the travel and expense application, automatically creating, for the new trip, a database search query for a plurality of data servers based on a plurality of search criteria associated with the candidate, the plurality of search criteria comprising a plurality of candidate preference data, candidate historical booking pattern, booking intents associated with the event, and the trip input data;
using the travel and expense application, automatically executing the database search query for the new trip to provide a plurality of recommendations comprising commute options and accommodation options based on the plurality of search criteria;
using the travel and expense application, receiving a selection of one of a commute option and an accommodation option among the plurality of recommendations for the new trip, and in response to receiving the selection, automatically creating booking information corresponding to booking a commute option among the commute options and an accommodation option among the accommodation options;
using the travel and expense application, updating an itinerary of the new trip of the candidate with the booking information and presenting the booking information and the plurality of recommendations at a graphical user interface (GUI) of the computing device of the candidate.

2. The computer-implemented method of claim 1, further comprising:
automatically storing the database search query associated with the plurality of search criteria in the plurality of trip database records of the travel database for execution of the database search query during a new search;
populating the travel database with the database search query; and
in response to initiating the new search, executing the database search query to retrieve the plurality of recommendations based on the plurality of search criteria.

3. The computer-implemented method of claim 1, further comprising:
computing weight value for each of the plurality of search criteria; and
providing the plurality of recommendations based on comparison of the weight value with prices associated with the plurality of recommendations.

4. The computer-implemented method of claim 1, further comprising applying a plurality of optimizing options and executing the database search query for the new trip based on the plurality of optimizing options.

5. The computer-implemented method of claim 1, further comprising presenting an explanation of the booking information and the plurality of recommendations at the GUI of the computing device of the candidate.

6. The computer-implemented method of claim 1, further comprising removing duplicates of recommendations from the plurality of recommendations and creating diversity of the plurality of recommendations.

7. The computer-implemented method of claim 1, further comprising:
determining an event type of the event;
determining other travelers registered for the event, wherein a commute option and an accommodate option are registered for the event type; and
automatically updating the itinerary of the new trip of the candidate and itineraries of the other travelers with the registered commute option and accommodation option.

8. The computer-implemented method of claim 7, wherein the itinerary of the new trip of the candidate and the itineraries of the other travelers comprises travel date and travel time stamps specifying event segments of the event and changes to the travel date and travel time stamps corresponding to changes of the event segments.

9. A computer system, comprising:
one or more processors;
one or more non-transitory computer-readable media coupled to the one or more processors and storing one or more sequences of stored program instructions which when executed using the one or more processors cause the one or more processors to execute:
using a travel and expense application, receiving trip input data comprising an origin of travel, a destination of the travel, and a period of an event from a web-based application implemented in a computing device of a candidate, the trip input data associated with an event record having an event identifier of the event;
using the travel and expense application, populating a plurality of trip fields of a travel database comprising a plurality of trip database records with the event identifier associated with the trip input data to automatically create and store a trip record for a new trip of the candidate, the travel database is communicatively coupled to the travel and expense application;
using the travel and expense application, automatically creating, for the new trip, a database search query for a plurality of data servers based on a plurality of search criteria associated with the candidate, the plurality of search criteria comprising a plurality of candidate preference data, candidate historical booking pattern, booking intents associated with the event, and the trip input data;
using the travel and expense application, automatically executing the database search query for the new trip to provide a plurality of recommendations comprising commute options and accommodation options based on the plurality of search criteria;
using the travel and expense application, receiving a selection of one of a commute option and an accommodation option among the plurality of recommendations for the new trip, and in response to receiving the selection, automatically creating booking information corresponding to booking a commute option among the commute options and an accommodation option among the accommodation options;
using the travel and expense application, updating an itinerary of the new trip of the candidate with the booking information and presenting the booking information and the plurality of recommendations at a graphical user interface (GUI) of the computing device of the candidate.

10. The computer system of claim 9, the one or more non-transitory computer-readable media further comprising sequences of stored program instructions which when executed using the one or more processors cause the one or more processors to execute:
using a travel and expense application, receiving trip input data comprising an origin of travel, a destination of the travel, and a period of an event from a web-based application implemented in a computing device of a candidate, the trip input data associated with an event record having an event identifier of the event;
using the travel and expense application, populating a plurality of trip fields of a travel database comprising a plurality of trip database records with the event identifier associated with the trip input data to automatically create and store a trip record for a new trip of the candidate, the travel database is communicatively coupled to the travel and expense application;
using the travel and expense application, automatically creating, for the new trip, a database search query for a plurality of data servers based on a plurality of search criteria associated with the candidate, the plurality of search criteria comprising a plurality of candidate preference data, candidate historical booking pattern, booking intents associated with the event, and the trip input data;
using the travel and expense application, automatically executing the database search query for the new trip to provide a plurality of recommendations comprising commute options and accommodation options based on the plurality of search criteria;
using the travel and expense application, receiving a selection of one of a commute option and an accommodation option among the plurality of recommendations for the new trip, and in response to receiving the selection, automatically creating booking information corresponding to booking a commute option among the commute options and an accommodation option among the accommodation options;
using the travel and expense application, updating an itinerary of the new trip of the candidate with the booking information and presenting the booking information and the plurality of recommendations at a graphical user interface (GUI) of the computing device of the candidate.

11. The computer system of claim 9, the one or more non-transitory computer-readable media further comprising sequences of stored program instructions which when executed using the one or more processors cause the one or more processors to execute:
computing weight value for each of the plurality of search criteria; and
providing the plurality of recommendations based on comparison of the weight value with prices associated with the plurality of recommendations.

12. The computer system of claim 11, the one or more non-transitory computer-readable media further comprising sequences of stored program instructions which when executed using the one or more processors cause the one or more processors to execute: applying a plurality of optimizing options and executing the database search query for the new trip based on the plurality of optimizing options.

13. The computer system of claim 9, the one or more non-transitory computer-readable media further comprising sequences of stored program instructions which when executed using the one or more processors cause the one or more processors to execute presenting an explanation of the booking information and the plurality of recommendations at the GUI of the computing device of the candidate.

14. The computer system of claim 9, the one or more non-transitory computer-readable media further comprising sequences of stored program instructions which when executed using the one or more processors cause the one or more processors to execute removing duplicates of recommendations from the plurality of recommendations and creating diversity of the plurality of recommendations.

15. The computer system of claim 9, the one or more non-transitory computer-readable media further comprising sequences of stored program instructions which when executed using the one or more processors cause the one or more processors to execute:
determining an event type of the event;
determining other travelers registered for the event, wherein a commute option and an accommodate option are registered for the event type; and
automatically updating the itinerary of the new trip of the candidate and itineraries of the other travelers with the registered commute option and accommodation option.

16. The computer system of claim 15, wherein the itinerary of the new trip of the candidate and the itineraries of the other travelers comprises travel date and travel time stamps specifying event segments of the event and changes to the travel date and travel time stamps corresponding to changes of the event segments.

17. One or more non-transitory computer-readable storage media storing one or more sequences of instructions which when executed by one or more processors cause the one or more processors to perform:
using a travel and expense application, receiving trip input data comprising an origin of travel, a destination of the travel, and a period of an event from a web-based application implemented in a computing device of a candidate, the trip input data associated with an event record having an event identifier of the event;
using the travel and expense application, populating a plurality of trip fields of a travel database comprising a plurality of trip database records with the event identifier associated with the trip input data to automatically create and store a trip record for a new trip of the candidate, the travel database is communicatively coupled to the travel and expense application;
using the travel and expense application, automatically creating, for the new trip, a database search query for a plurality of data servers based on a plurality of search criteria associated with the candidate, the plurality of search criteria comprising a plurality of candidate preference data, candidate historical booking pattern, booking intents associated with the event, and the trip input data;
using the travel and expense application, automatically executing the database search query for the new trip to provide a plurality of recommendations comprising commute options and accommodation options based on the plurality of search criteria;
using the travel and expense application, receiving a selection of one of a commute option and an accommodation option among the plurality of recommendations for the new trip, and in response to receiving the selection, automatically creating booking information corresponding to booking a commute option among the commute options and an accommodation option among the accommodation options;
using the travel and expense application, updating an itinerary of the new trip of the candidate with the booking information and presenting the booking information and the plurality of recommendations at a graphical user interface (GUI) of the computing device of the candidate.

18. The one or more non-transitory computer-readable storage media of claim 17, further comprising sequences of instructions which when executed cause the one or more processors to perform:
computing weight value for each of the plurality of search criteria; and
providing the plurality of recommendations based on comparison of the weight value with prices associated with the plurality of recommendations.

19. The one or more non-transitory computer-readable storage media of claim 17, further comprising sequences of instructions which when executed cause the one or more processors to perform removing duplicates of recommendations from the plurality of recommendations and creating diversity of the plurality of recommendations.

20. The one or more non-transitory computer-readable storage media of claim 17, further comprising sequences of instructions which when executed cause the one or more processors to perform:
determining an event type of the event;
determining other travelers registered for the event, wherein a commute option and an accommodate option are registered for the event type; and
automatically updating the itinerary of the new trip of the candidate and itineraries of the other travelers with the registered commute option and accommodation option.
